(19) United States
(12) Patent Application Publication
(10) Pub. No.: US 2009/0095325 A1
(43) Pub. Date: Apr. 16, 2009

(54) Substrate processing apparatus and method of cleaning the same

(76) Inventors: Chung-Sic Choi, Seoul (KR); Rae-Taek Oh, Chungcheongnam-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/287,575

(22) Filed: Oct. 10, 2008

(30) Foreign Application Priority Data
Oct. 11, 2007 (KR) 2007-102489

(51) Int. Cl. B08B 9/093

(52) U.S. Cl. 134/24; 134/153; 134/104.1

(57) ABSTRACT

Provided are a substrate processing apparatus and a method for cleaning the same. In the substrate processing apparatus, a substrate supporting member includes a spin head on which a substrate is mounted, a rotary joint, and a supply pipe for supplying solution. The rotary joint receives a supply of solution from the supply pipe and supplies the solution to the spin head. The spin head has at least one spray hole formed for spraying the solution, and sprays the solution axially while spinning. Accordingly, the substrate supporting member can provide solution to the inner walls of the processing container, to raise cleaning efficiency of the processing container and increase manufacturing yield.

### CROSS-REFERENCE TO RELATED APPLICATION

This U.S. non-provisional patent application claims priority under 35 U.S.C. §119 of Korean Patent Application No. 10-2007-0102489, filed on Oct. 11, 2007, the entire contents of which are hereby incorporated by reference.

### BACKGROUND

The present invention disclosed herein relates to a substrate processing apparatus, and more particularly, to a substrate processing apparatus for processing a semiconductor substrate using a processing solution, and a method of cleaning the same.

Various processes, such as deposition, photo, etch, and polishing, are required in semiconductor device manufacturing.

In general, semiconductor processing is performed inside a predetermined container in which a wafer is disposed and processed with process solution or process gas. Such semiconductor processing characteristically generates particles, which easily adhere to the inner walls of the container. In particular, chemical solution used as process solution for processing wafer can react with air and generate salt, and the salt adheres to the inner walls of the chamber.

When such impurities continually amass on the inner walls of the container, in subsequent semiconductor processing, the impurities may float inside the container and adhere to the wafer, causing defects in the wafer.

To prevent such occurrences, the inside of the container requires regular cleaning. Methods for cleaning the container include manual cleaning by an operator and the use of a dummy wafer. The method of manual cleaning involves first disassembling all the containers and then manually cleaning the inner wall of each container by the operator. When manual cleaning of the containers is thus performed, the time required to clean the containers is prolonged, thus reducing work efficiency and yield. Yield is reduced because the containers cannot be used for semiconductor processing while being cleaned.

In the method of using a dummy wafer, the dummy wafer is first mounted on a spin head, then which the dummy wafer is spun and cleaning solution is provided on the dummy wafer. The cleaning solution provided on the dummy wafer is sprayed on the inner walls of the container to clean the container, by means of centrifugal force of the spinning dummy wafer. However, to increase yield, a semiconductor processing system is provided with a plurality of containers, and semiconductor processing is simultaneously performed in each of the containers. Accordingly, when a dummy wafer is used in one of the containers to perform cleaning, the remaining containers remain unproductive when awaiting their turn to be cleaned. Therefore, the time for cleaning the containers is extensive, and work efficiency and yield are lowered.

### SUMMARY

The present invention provides a substrate processing apparatus with improved substrate cleaning efficiency and yield.

The present invention also provides a method of cleaning for the above substrate processing apparatus.

Embodiments of the present invention provide substrate supporting members including a spin head, a fixed shaft, a supply pipe, and a rotary joint.

The spin head has a substrate mounted thereon, rotates in one direction, and defines at least one spray hole that sprays a fluid sideways. The fixed shaft is coupled to the spin head to support the spin head. The supply pipe is disposed inside the fixed shaft to convey the fluid. The rotary joint is coupled to the spin head and the fixed shaft, to receive the fluid conveyed by the supply pipe and provide the fluid to the spray hole.

Specifically, the spray hole may be defined to extend from a side surface of the spin head toward a central axis of the spin head.

The rotary joint may include a body part, a rotating part, and at least one bearing. The body part may be fixed to the fixed shaft and may include at least one supply hole through which the fluid enters from the supply pipe. The rotating part may be coupled to and rotate in concert with the spin head, and may include at least one discharge hole coupling to the fixed shaft to receive the fluid and discharge the received fluid. The bearing may be interposed between the rotating part and the body part to couple the rotating part to the body part.

The substrate supporting member may further include at least one cleaning pipe coupling to the rotating part and the spin head, to provide the fluid discharged from the discharge hole to the spray hole.

The substrate supporting member may further include at least one connecting pipe coupling to the body part and the supply pipe, to provide the fluid discharged from the supply pipe to the body part.

In other embodiments of the present invention, substrate processing apparatuses include a processing container and a substrate supporting member.

The processing container provides a space in which processing of a substrate is performed. The substrate supporting member is disposed inside the processing container to fix the substrate, and defines at least one spray hole that sprays a fluid toward the processing container to clean the processing container.

Methods for cleaning substrate processing apparatuses according to above-described embodiments are as follows. First, a fluid is provided to a substrate supporting member disposed inside a processing container. The substrate supporting member is rotated, and the fluid from the substrate supporting member is simultaneously sprayed to clean the processing container. Here, the fluid is sprayed from a side surface of the substrate supporting member.

The substrate supporting member may be adjusted in position vertically within the processing container while the fluid is sprayed.

The fluid may include a cleaning solution for cleaning the processing container, and a drying gas for drying the processing container.

Specifically, with respect to the cleaning of the processing container, first, the processing container may be cleaned through the substrate supporting member rotating and spraying the cleaning solution. Then, the processing container may be dried through the substrate supporting member rotating and spraying the drying gas.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a perspective view of a substrate processing apparatus according to an embodiment.

FIG. 2 is a cross-sectional view of a processing container and a substrate holding member in FIG. 1.

FIG. 3 is a cross-sectional view of the substrate supporting member illustrated in FIG. 2.

FIG. 4 is a perspective view of the substrate supporting member illustrated in FIG. 3.

FIG. 5 is a plan view of a spin head illustrated in FIG. 4.

FIG. 6 is a perspective view illustrating the coupling of a rotary joint and the surrounding mechanism illustrated in FIG. 3.

FIG. 7 is a detailed perspective view of the rotary joint illustrated in FIG. 6.

FIG. 8 is a cross-sectional view illustrating a process of cleaning a processing container in the substrate processing apparatus in FIG. 2.

FIG. 9 is a plan view illustrating a process of spraying cleaning fluid from the substrate supporting member illustrated in FIG. 8.

### DETAILED DESCRIPTION OF PREFERRED EMBODIMENTS

Preferred embodiments of the present invention will be described below in more detail with reference to the accompanying drawings. The present invention may, however, be embodied in different forms and should not be construed as limited to the embodiments set forth herein. Rather, these embodiments are provided so that this disclosure will be thorough and complete, and will fully convey the scope of the present invention to those skilled in the art.

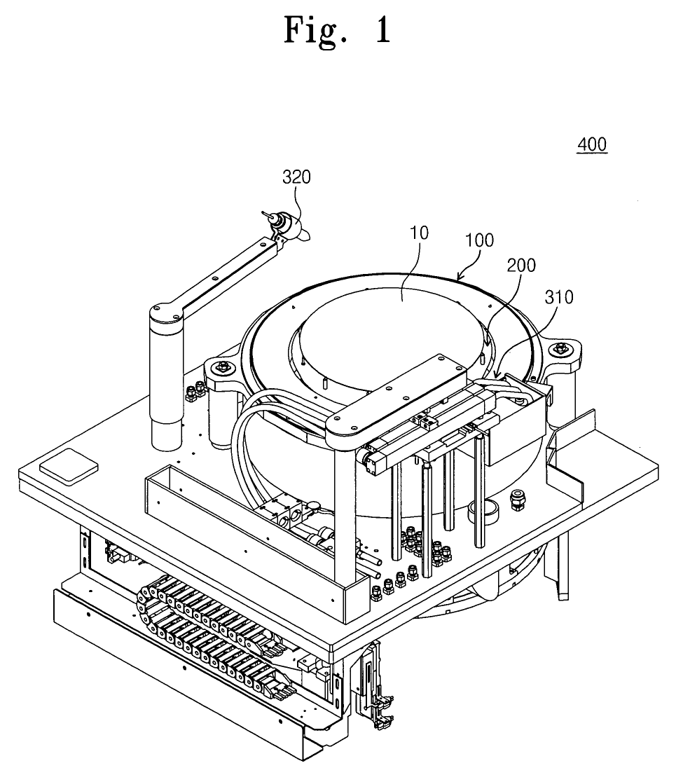

FIG. 1 is a perspective view of a substrate processing apparatus according to an embodiment.

Referring to FIG. 1, a substrate processing apparatus 400 includes a processing container 100, a substrate supporting member 200, and a plurality of nozzles 310 and 320.

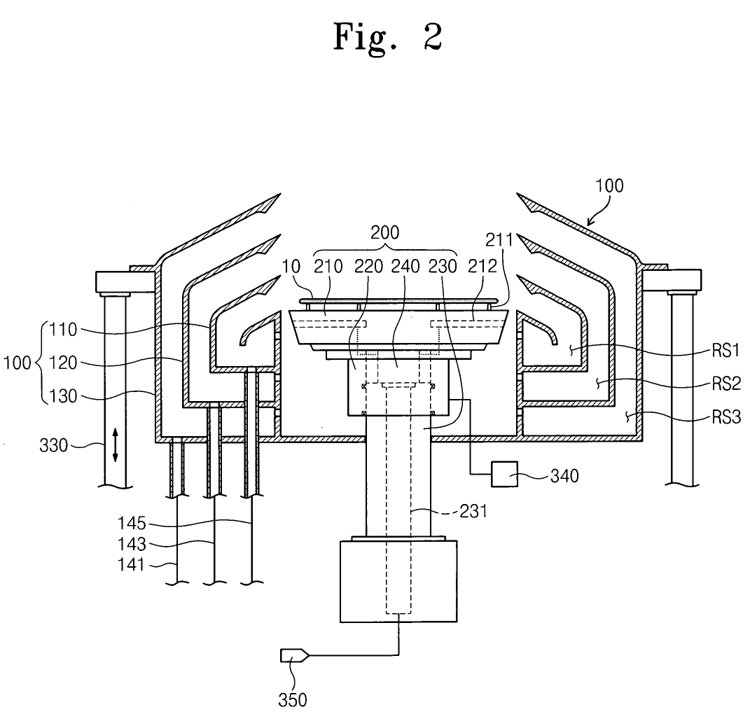

The processing container 100 is cylindrical with the top open, and provides a processing space to process a wafer 10. The open top of the processing container 100 is provided as an extraction and insertion package for the wafer 10. The processing space holds the substrate supporting member 200. The substrate supporting member 200 fixes the wafer 10 inserted in the processing container 100 while processing is performed on the wafer 10. The configuration of the processing container 100 and the substrate supporting member 200 will be described in detail below, with reference to FIGS. 2 through 7.

A plurality, of nozzles 310 and 320 is provided at the outside of the processing container 100. The nozzles 310 and 320 supply processing solution or processing gas for cleaning or etching the wafer 10 to the wafer 10 fixed to the substrate supporting member 200.

In FIG. 1, while the wafer 10 is illustrated as an example of a substrate that the substrate processing apparatus 400 processes, the present invention is not limited thereto, and the substrate may be a glass substrate or any one of various other types of substrates.

Below, with reference to figures, a detailed description will be provided of the processing container 100 and the substrate supporting member 200.

FIG. 2 is a cross-sectional view of a processing container and a substrate holding member in FIG. 1.

Referring to FIG. 2, the processing container 100 is provided with cylindrical first, second, and third collection containers 110, 120, and 130. In the present embodiment, while the processing container 100 is formed of the three collection containers 110, 120, and 130, the number of collection containers 110, 120, and 130 may be increased or reduced.

The first through third collection containers 110, 120, and 130 recover processing solution supplied to a wafer 10 during processing of the wafer 10. That is, the substrate processing apparatus 400 spins the wafer 10 with the substrate supporting member 200, and uses processing solution to process the wafer 10. Thus, the processing solution supplied to the wafer 10 is scattered, and the first through third collection containers 110, 120, and 130 recover the processing solution scattered from the wafer 10.

In detail, the first through third collection containers 110, 120, and 130 are each provided with an annular bottom surface and round side walls that extend from the bottom surface. The second collection container 120 encloses the first collection container 110 and is apart from the first collection container 110. The third collection container 130 encloses the second collection container 120 and is apart from the second collection container 120.

The first through third collection containers 110, 120, and 130 define first through third collection spaces RS1, RS2, and RS3, respectively, into which processing solution scattered from the wafer 10 enters. The first collection space RS1 is defined by the first collection container 110, to recover a first processing solution used in a first processing of the wafer 10. The second collection space RS2 is defined in the space between the first collection container 110 and the second collection container 120, to recover a second processing solution used in a second processing of the wafer 10. The third collection space RS3 is defined in the space between the second collection container 120 and the third collection container 130, to recover a third processing solution used in a third processing of the wafer 10. Here, the third processing solution may be a rinse solution for rinsing the wafer 10.

While in the above, a description has been given of an example where processing solutions are recovered in sequence by the first through third collection containers 110, 120, and 130, according to the processing sequence of the wafer 10; however, the order in which processing solution is recovered by the first through third collection containers 110, 120, and 130 may be altered according to the processing sequence of the wafer 10 and the positions of the wafer 10.

The first through third collection containers 110, 120, and 130 each have an upper surface with an opening in the center. The upper surfaces are inclines, a distance between respective incline and the opposite bottom surface progressively increase from their connections at the side wall toward the openings. Therefore, processing solution scattered from the wafer 10 is guided along the upper surfaces of the first through third collection containers 110, 120, and 130 into the collection spaces RS1, RS2, and RS3.

The first collection container 110 is connected to a first collection line 141. The first processing solution that enters the first collection space RS1 and is expelled to the outside through the first collection line 141. The second collection container 120 is connected to a second collection line 143. The second processing solution that enters the second collection space RS2 and is expelled to the outside through the second collection line 143. The third collection container 130 is connected to a third collection line 145. The third processing solution that enters the third recovery space RS3 and is expelled to the outside through the third collection line 145.

The processing container 100 is coupled to an elevator 330 that changes the vertical position of the processing container 100. The elevator 330 is provided at the outer wall of the third collection container 130, to raise/lower the processing container 100 with the vertical position of the substrate supporting member 200 fixed. Accordingly, the relative vertical positions of the processing container 100 and the wafer 10 disposed on the substrate supporting member 200 are altered. Thus, the processing container 100 can change which of the collection spaces RS1, RS2, and RS3 is used to recover different types of processing solution and contaminated gas.

In the present embodiment, the substrate processing apparatus 400 moves the processing container 100 vertically to alter the relative vertical positions of the processing container 100 and the wafer 10 dispose on the substrate supporting member 200. However, the substrate processing apparatus 400 may vertically move the substrate supporting member 200 to alter the relative vertical positions of the processing container 100 and the wafer disposed on the substrate supporting member 200.

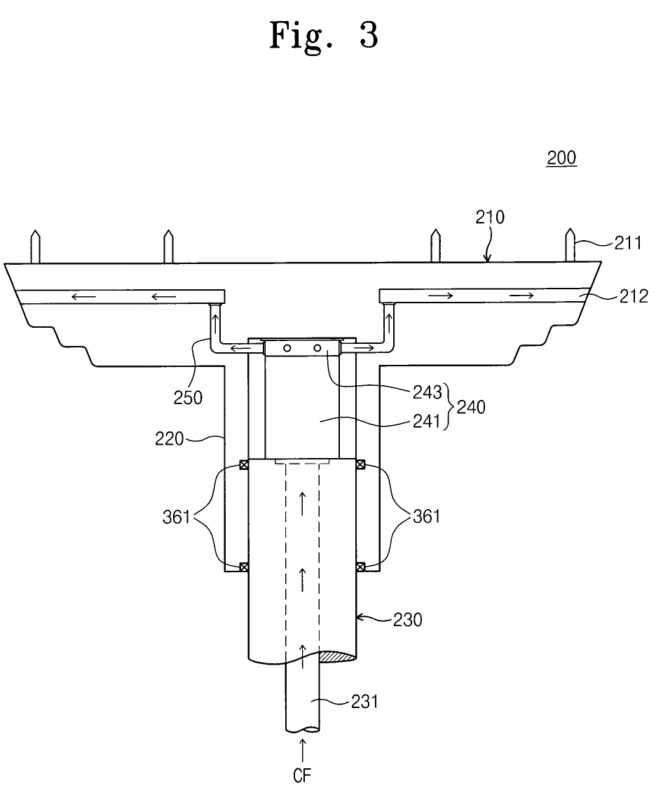

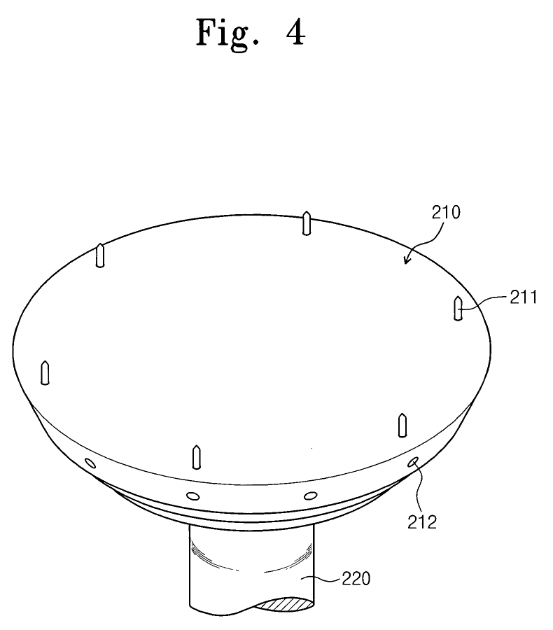

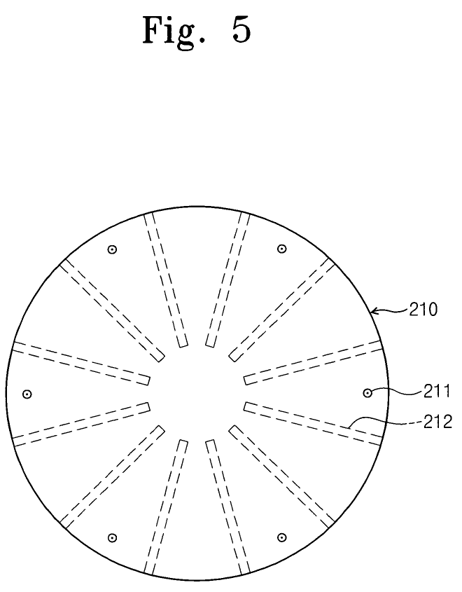

FIG. 3 is a cross-sectional view of the substrate supporting member illustrated in FIG. 2, FIG. 4 is a perspective view of the substrate supporting member illustrated in FIG. 3, and FIG. 5 is a plan view of a spin head illustrated in FIG. 4.

Referring to FIGS. 2 and 3, the substrate supporting member 200 is held inside the processing container 100. The substrate supporting member 200 includes a spin head 210, a rotating shaft 220, a fixed shaft 230, a rotary joint 240, and a plurality of cleaning pipes 250.

Referring to FIGS. 4 and 5, the spin head 210 has a round plate shape, and the top surface thereof faces the wafer 10. The top surface of the spin head 210 is provided with a plurality of chuck pins 211 that support the wafer 10. The chuck pins 211 chucks the wafer 10 to fix the wafer 10 on the spin head 210.

A plurality of spray holes 212 is defined in the side surface of the spin head 210. The spray holes 212 are defined apart from one another to respectively extend from the side surface of the spin head 210 toward the center of the spin head 210. Accordingly, when viewed from the top of the spin head 210, the spray holes are disposed in a radial shape.

The rotating shaft 220 is coupled at the rear face of the spin head 210. The rotating shaft 220 is connected to a rotating driver 340, and rotates by rotational force generated by the rotating driver 340. The rotational force of the rotating shaft 220 is transferred to the spin head 210 to rotate the spin head 210, so that the wafer 10 fixed on the spin head 210 is rotated.

Referring again to FIGS. 2 and 3, the rotating shaft 220 is coupled to the fixed shaft 230. The fixed shaft 230 has one end inserted in the rotating shaft 220, and employs a plurality of bearings 361 to couple with the rotating shaft 220. Accordingly, the fixed shaft 230 does not rotate, and only the rotating shaft 220 rotates. The fixed shaft 230 has a supply pipe 231 built-in.

The supply pipe 231 extends along the length of the fixed shaft 230, and is connected to an external fluid supply 350. The fluid supply 350 supplies cleaning fluid CF for cleaning the processing container 100. The cleaning fluid CF includes a cleaning solution for cleaning the processing container 100, and a drying gas for drying the processing container 100. An example of a cleaning solution is de-ionized(DI) water and an example of the drying gas is nitrogen gas. The fluid supply 350 first provides the cleaning solution to the supply pipe 231 to clean the process container 400 and supplies the drying gas after the cleaning of the processing container 100 is completed.

The discharging end of the supply pipe 231 is coupled to the rotary joint 240, and the supply pipe 231 provides the cleaning fluid CF to the rotary joint 240.

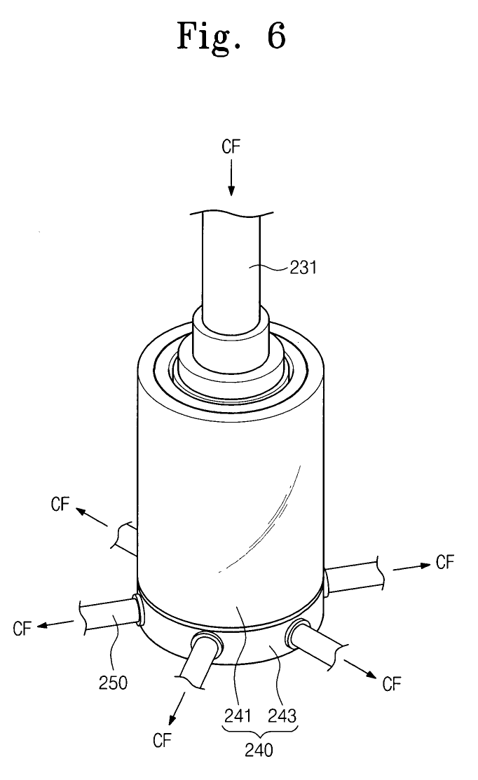

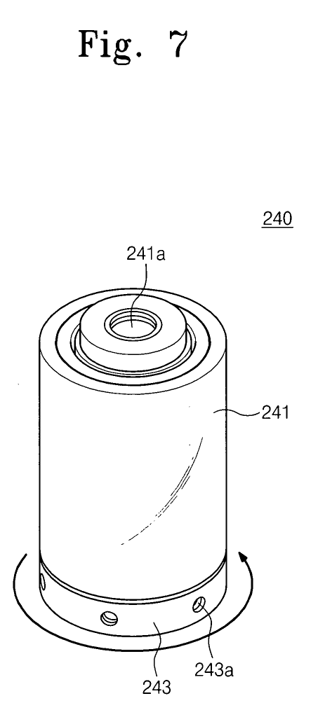

FIG. 6 is a perspective view illustrating the coupling of a rotary joint and the surrounding mechanism illustrated in FIG. 3, and FIG. 7 is a detailed perspective view of the rotary joint illustrated in FIG. 6.

Referring to FIGS. 3 and 6, the rotary joint 240 is installed within the rotating shaft 220, and coupled to the spin head 210 and the fixed shaft 230. In the present embodiment, the rotary joint 240 has a cylindrical shape; however, it may be of another shape.

The rotary joint 240 may include a body part 241 coupled to the fixed shaft 230 and a rotating part 243 coupled to the spin head 210.

Referring to FIGS. 6 and 7, the body part 241 defines at least one supply hole 241a, and the supply hole 241a is connected to the discharging end of the supply pipe 231. Accordingly, the cleaning fluid CF from the supply pipe 231 is supplied to the body part 241.

In the present embodiment, the body part 241 defines the supply hole 241a at the lower surface coupled with the fixed shaft 230 (in FIG. 3) and the supply hole 241a is directly connected with the supply pipe 231. However, the supply hole 241a may be defined in the side surface of the body part 241. In this case, the substrate supporting member 200 may be provided with a separate connecting pipe that connects the supply hole defined in the side surface of the body part 241 to the supply pipe 231.

The body part 241 is coupled to the rotating part 243 through a bearing (not shown). Thus, with the body part 241 fixed, only the rotating part 243 can rotate. The rotating part 243 defines a plurality of discharge holes 243a in its side surface. The discharge holes 243a are distanced apart from one another, and discharge the cleaning fluid CF from the body part 241. The discharge holes 243a are connected to the plurality of cleaning pipes 250.

Each of the cleaning pipes 250 is connected to one of the discharge holes, and receives the cleaning fluid CF through a corresponding discharge hole 243a. In the present embodiment, the numbers of the discharge holes 243a and the cleaning pipes 250 are determined by the number of the spray holes 212.

Referring once more to FIGS. 2 and 3, the discharge ends of the cleaning pipes 250 are connected to the spray holes 212. Each spray hole 212 receives the cleaning fluid CF supplied through the cleaning pipe to which it is connected, and the cleaning fluid CF is sprayed at the inner wall of the processing container 100 to clean the processing container 100.

In particular, the spray holes 212 are defined in the side surface of the spin head 210 facing the sidewalls of the first through third collection containers 110, 120, and 130. Accordingly, the clean fluid CF is sprayed from the side surface of the spin head 210 toward the inner wall of the processing container 100—that is, the sidewalls and upper surfaces of the first and second collection containers 110 and 120 and the inner wall of the third collection container 130.

Also, the spin head 210 sprays the cleaning fluid CF while being rotated in one direction by the driving of the rotating driver 340. Therefore, the spray pressure of the cleaning fluid CF sprayed from the spin head 210 is raised, so that the cleaning fluid CF is uniformly sprayed onto the inner walls of the first through third collection containers 110, 120, and 130.

While the cleaning process using the cleaning fluid CF of the processing container 100 is being performed, the relative vertical heights of the spin head 210 and the floor of and the processing container 100 are altered. Thus, the cleaning fluid CF supplied from the spin head 210 is uniformly sprayed to each of the first through third collection containers 110, 120, and 130.

Likewise, the spin head 210 sprays the cleaning fluid CF from the side surfaces thereof while spinning, to clean the processing container 100. Therefore, in order to clean a processing container 100 of the substrate processing apparatus 400, it is not necessary to disassemble the processing container 100 or use a dummy wafer. Accordingly, the substrate processing apparatus 400 can reduce the time for cleaning a processing container 100, increase cleaning efficiency, and raise production and product yield.

While not illustrated in the diagrams, the substrate processing apparatus 400 may further include a back nozzle. The back nozzle may be provided on the substrate supporting member 200 to supply cleaning solution or processing gas for cleaning the rear surface of the wafer 10.

Below, detailed description of methods for cleaning the processing container 100 will be provided, with reference to the figures.

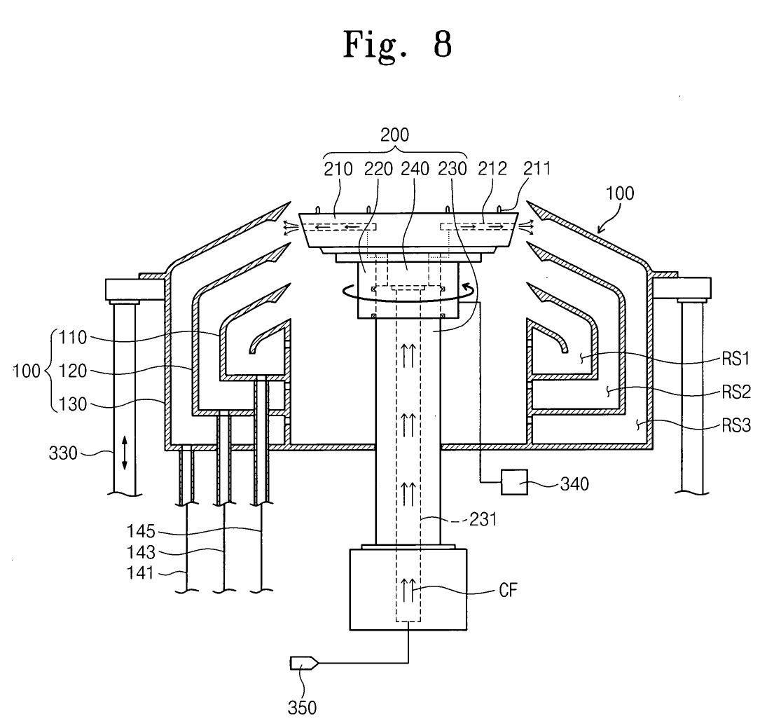

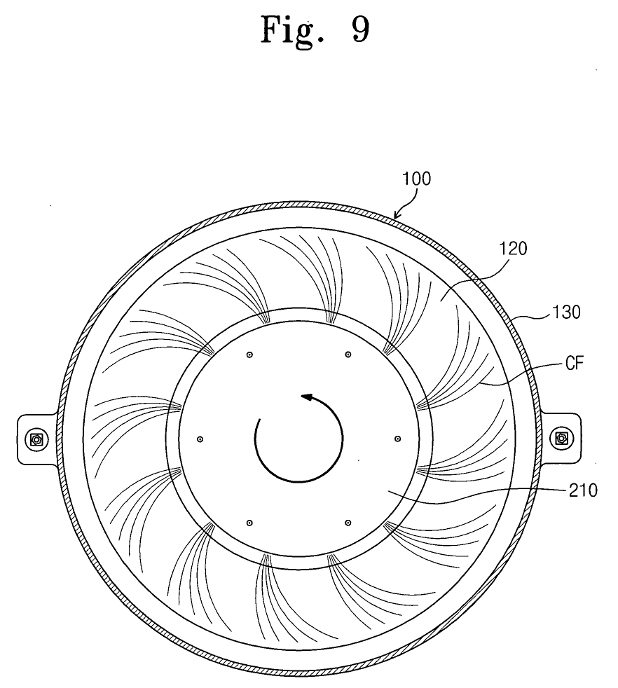

FIG. 8 is a cross-sectional view illustrating a process of cleaning a processing container in the substrate processing apparatus in FIG. 2, and FIG. 9 is a plan view illustrating a process of spraying cleaning fluid from the substrate supporting member illustrated in FIG. 8. To clearly depict the cleaning fluid CF sprayed from the spin head 210, FIG. 9 illustrates the third collection container 130 partially cut.

Referring to FIGS. 3 and 8, the processing container 100 is first moved vertically through the operation of the elevator 330, so that the upper surface of the spin head 210 is adjacent to the upper surface of the third collection container 130.

Next, the rotating shaft 220 is rotated by the rotating driver 340, and the spin head 210 is rotated in one direction by the rotation of the rotating shaft 220. At the same time, the rotating part 243 of the rotary joint 240 coupled to the spin head 210 rotates in the same direction as the spin head 210.

The fluid supply 350 supplies the cleaning fluid CF to the supply pipe 231 and the supply pipe 231 supplies the cleaning fluid CF to the body part 241 of the rotary joint 240. Here, the fluid supply 350 first provides the cleaning solution from amongst the cleaning solution and the drying gas.

The rotating part 243 of the rotary joint 240 rotates in concert with the spin head 210 and provides the cleaning solution to the cleaning pipes 250. Because a portion of the rotary joint 240 is fixed to the fixed shaft 230 and a portion rotates with the spin head 210, the cleaning solution can be reliably supplied to the spinning spin head 210.

The cleaning pipes 250 supply the cleaning solution to the spray holes 212 and the cleaning solution supplied to the spray holes 212 is sprayed toward the inner wall of the third collection container 130.

Referring to FIGS. 8 and 9, the spin head 210 rotates in one direction and sprays the cleaning solution. Accordingly, the spray pressure of the cleaning solution is raised, and the cleaning solution is sprayed uniformly on the inner wall of the third collection container 130, thus increasing cleaning efficiency.

The cleaning solution is sprayed from the side surface of the spin head 210 to between the third collection container 130 and the second collection container 120, to thus clean the inner wall of the third collection container 130 and the outside of the second collection container 120.

When the cleaning of the third collection container 130 using the cleaning solution is completed, the elevator 330 raises the processing container 100 so that the upper surface of the spin head 210 is adjacent to the upper surface of the second collection container 120. Accordingly, the cleaning solution from the spin head 210 is sprayed at the inner wall of the second collection container 120 and the outside of the first collection container 110 to clean the second collection container 120.

When the cleaning with the cleaning solution of the second collection container 120 is completed, the elevator 330 raises the processing container 100 so that the upper surface of the spin head 210 is adjacent to the upper surface of the first collection container 110. Accordingly, the cleaning solution from the spin head 210 is sprayed at the inner wall of the first collection container 110 to clean the first collection container 110.

In the present embodiment, the substrate processing apparatus 400 sequentially moves the vertical position of the spin head 210 from the third collection container 130 to the first collection container 110 to clean the processing container 100. However, the vertical position of the spin head 210 may be moved oppositely from the first collection container 110 to the third collection container 130 to clean the processing container 100.

When cleaning of the first through third collection containers 110, 120, and 130 using the cleaning fluid is completed, the fluid supply 350 provides drying gas to the substrate supporting member 200, and the spin head 210 sprays the drying gas to dry the first through third collection containers 110, 120, and 130.

The process of spraying of the drying gas by the substrate supporting member 200 is the same as that of spraying the cleaning solution, and thus, a detailed description thereof will be omitted.

A brief description of a process for spraying the drying gas by the substrate supporting member 200 will be provided as follows. First, the fluid supply 350 provides the drying gas to the supply pipe 231, and the supply pipe 231 provides the drying gas to the rotary joint 240. The rotary joint 240 provides the drying gas to the rotating spin head 210 through the cleaning pipes 240. The spin head 210 sprays the drying gas as it spins, to dry the processing container 100.

As described above, a substrate processing apparatus according to the present invention employs a substrate supporting member on which a substrate is mounted, to clean the inner walls of a processing container. Accordingly, because the substrate processing apparatus can clean a processing container without disassembling the processing container or using a dummy wafer, cleaning time can be reduced, and cleaning efficiency, productivity, and product yield can be improved.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A substrate supporting member comprising:
a spin head on which a substrate is mounted and which rotates in one direction, the spin head defining at least one spray hole that sprays a fluid sideways;
a fixed shaft coupled to the spin head to support the spin head;
a supply pipe disposed inside the fixed shaft to convey the fluid; and
a rotary joint coupling to the spin head and the fixed shaft, to receive the fluid conveyed by the supply pipe and provide the fluid to the spray hole.

2. The substrate supporting member of claim 1, wherein the spray hole is defined to extend from a side surface of the spin head toward a central axis of the spin head.

3. The substrate supporting member of claim 1, wherein the rotary joint comprises:
a body part fixed to the fixed shaft and comprising at least one supply hole through which the fluid enters from the supply pipe;
a rotating part coupled to and rotating in concert with the spin head, the rotating part comprising at least one discharge hole coupling to the fixed shaft to receive the fluid and discharge the received fluid; and
at least one bearing interposed between the rotating part and the body part to couple the rotating part to the body part.

4. The substrate supporting member of claim 3, further comprising at least one cleaning pipe coupling to the rotating part and the spin head, to provide the fluid discharged from the discharge hole to the spray hole.

5. The substrate supporting member of claim 4, further comprising at least one connecting pipe coupling to the body part and the supply pipe, to provide the fluid discharged from the supply pipe to the body part.

6. A substrate processing apparatus comprising:
a processing container providing a space in which processing of a substrate is performed; and
a substrate supporting member disposed inside the processing container to fix the substrate, and defining at least one spray hole that sprays a fluid toward the processing container to clean the processing container.

7. The substrate processing apparatus of claim 6, wherein the substrate supporting member comprises:
a spin head on which the substrate is mounted, and which spins in one direction and defines the spray hole;
a fixed shaft coupled to the spin head to support the spin head;
a supply pipe disposed inside the fixed shaft to convey the fluid; and
a rotary joint coupling to the spin head and the fixed shaft, to receive the fluid from the supply pipe and provide the fluid to the spray hole.

8. The substrate processing apparatus of claim 7, wherein the spray hole is defined extending from a side surface of the spin head toward a central axis of the spin head.

9. The substrate processing apparatus of claim 7, wherein the rotary joint comprises:
a body part fixed to the fixed shaft, and comprising at least one supply hole into which the fluid from the supply pipe enters;
a rotating part coupled to and rotating together with the spin head, and comprising at least one discharge hole coupling with the fixed shaft to receive and discharge the fluid; and
at least one bearing interposed between the rotating part and the body part, to couple the rotating part with the body part.

10. The substrate processing apparatus of claim 9, further comprising at least one cleaning pipe coupling to the rotating part and the spin head, to provide the fluid discharged from the discharge hole to the spray hole.

11. The substrate processing apparatus of claim 10, further comprising at least one connecting pipe coupling to the body part and the supply pipe, to provide the fluid discharged from the supply pipe to the body part.

12. The substrate processing apparatus of claim 6, wherein the fluid is a cleaning solution for cleaning the processing container.

13. The substrate processing apparatus of claim 6, wherein the fluid is a drying gas for drying the processing container.

14. A method for cleaning a substrate processing apparatus, the method comprising:
providing a fluid to a substrate supporting member disposed inside a processing container; and
cleaning the processing container through rotating the substrate supporting member and simultaneously spraying the fluid from the substrate supporting member.

15. The method of claim 14, wherein the fluid is sprayed from a side surface of the substrate supporting member.

16. The method of claim 15, wherein the substrate supporting member is adjusted in position vertically within the processing container while the fluid is sprayed.

17. The method of claim 15, wherein the fluid comprises a cleaning solution for cleaning the processing container, and a drying gas for drying the processing container.

18. The method of claim 17, wherein the cleaning of the processing container comprises:
cleaning the processing container through the substrate supporting member rotating and spraying the cleaning solution; and
drying the processing container through the substrate supporting member rotating and spraying the drying gas.
